(19) United States
(12) Patent Application Publication
(10) Pub. No.: US 2026/0267871 A1
(43) Pub. Date: Sep. 10, 2026

(54) TECHNIQUES FOR MODELING AND QUERYING MULTI-DIMENSIONAL DATA FOR LARGE-SCALE ANALYTICS

(71) Applicant: People Center, Inc., San Francisco, CA (US)

(72) Inventors: Siddharth Raja, San Francisco, CA (US); Nilay Laxmikant Pochhi, San Francisco, CA (US); Andrei Savu, Menlo Park, CA (US); Nishant Gaurav, San Francisco, CA (US); Aden Dong, Toronto (CA); Rohit Sivakumar, Kitchener (CA); Utkarsh Jain, Kirkland, WA (US)

(21) Appl. No.: 19/562,395

(22) Filed: Mar. 10, 2026

Related U.S. Application Data
(60) Provisional application No. 63/769,589, filed on Mar. 10, 2025.

(51) Int. Cl. G06F 16/25; G06F 16/245

(52) U.S. Cl. CPC G06F 16/254; G06F 16/245; G06F 16/258

(57) ABSTRACT

Systems, devices, computer-implemented methods, and tangible non-transitory computer readable media for implementing an organizational management platform that manages organizational data for an organization. The system can access a document-oriented database that stores the organizational data associated with the organization. The system can access an online analytical processing (OLAP) database having a base table and a dimension table. The system can receive, from a user device, a user request for a report. The system can generate, based on the object graph data stored in the document-oriented database, a first query being expressed in a custom query language, the first query being associated with a first data. The system can retrieve, from the OLAP database, data from the base table based on the first query. The system can join, using the lookup data, the retrieved data with the data from the dimension table to generate the report.

### CROSS-REFERENCE TO PRIORITY APPLICATIONS

The present disclosure claims priority to U.S. Application No. 63/679,589, entitled “TECHNIQUES FOR MODELING AND QUERYING MULTI-DIMENSIONAL DATA FOR LARGE-SCALE ANALYTICS,” filed Mar. 10, 2025, the entirety of which is incorporated by reference herein.

### FIELD

The present disclosure generally relates to computing systems. More particularly, the present disclosure relates to optimizing data retrieval of multi-dimensional data from a database to generate reports.

### BACKGROUND

Most users lack the specialized knowledge, experience, and skills needed to write computer programs in a programming language. This usually prevents most non-programmers from developing and performing their own custom operations associated with organizational data and other types of information stored in computing systems. As such, most users generally are restricted to the applications and interfaces provided by computer programs written by computer programmers. Therefore, a need exists for providing tools that empower users with the ability to access, query, obtain, and/or perform other operations with organizational data and other types of information available in computing systems.

While a document-oriented database (e.g., NoSQL database) offers flexibility with a schema-less structure, this type of database has some limitations when it comes to query performance, especially for complex analytical queries.

### SUMMARY

Aspects and advantages of embodiments of the present disclosure will be set forth in part in the following description, or can be learned from the description, or can be learned through practice of the embodiments.

One example aspect of the present disclosure is directed to a computing system that implements an organizational management platform that manages organizational data for an organization. The computing system also includes one or more processors. The system also includes a document-oriented database that stores the organizational data associated with the organization, where the organizational data may include an object graph data structure may include a plurality of data objects that respectively correspond to a plurality of employees of the organization, and where each data object includes a dynamic attribute is defined by the organization. The system also includes an online analytical processing (OLAP) database having a base table and a dimension table, the base table storing raw data associated with the data objects, and the dimension table storing lookup data associated with the dynamic attribute. The system also includes one or more non-transitory computer-readable media that collectively store instructions that, when executed by the one or more processors, cause the computing system to perform operations. The system also includes receiving, from a user device, a user request for a report. The system also includes generating, based on the object graph data stored in the document-oriented database, a first query being expressed in a custom query language, the first query being associated with a first data object from the plurality of data objects. The system also includes retrieving, from the OLAP database, data from the base table based on the first query. The system also includes joining, using the lookup data, the retrieved data with the data from the dimension table to generate the report. Other embodiments of this aspect include corresponding computing systems, apparatus, and computer programs recorded on one or more computer storage devices, each configured to perform the actions of the methods.

Implementations may include one or more of the following features. The computing system where the dynamic attribute associated with an employee is defined by the organization. The data access language is used to access data from the OLAP database. The data access language is structured query language (SQL). The computing system the operations may include: storing new data received from a user of the organization in the document-oriented database; converting, using an automated extract, transform, and load (ETL) pipeline, the new data to converted data; and storing, using the object graph data structure, the converted data in the OLAP database. The document-oriented database is a NoSQL database. The OLAP database is a pinot database. The report is a job report based on the organizational data of the organization. The computing system the operations may include generating permission filters for the OLAP database based on user privileges of the user device. Implementations of the described techniques may include hardware, a method or process, or computer software on a computer-accessible medium.

One general aspect includes a computer-implemented method. The computer - implemented method also includes accessing a document-oriented database that stores the organizational data associated with the organization, where the organizational data may include an object graph data structure may include a plurality of data objects that correspond to a plurality of employees of the organization, and where each data object includes a dynamic attribute is defined by the organization. The method also includes accessing an OLAP database having a base table and a dimension table, the base table storing raw data associated with the data objects, and the dimension table storing lookup data associated with the dynamic attribute. The method also includes receiving, from a user device, a user request for a report. The method also includes generating, based on the object graph data stored in the document-oriented database, a first query being expressed in a custom query language, the first query being associated with a first data object from the plurality of data objects. The method also includes retrieving, from the OLAP database, data from the base table based on the first query. The method also includes joining, using the lookup data, the retrieved data with the data from the dimension table to generate the report. Other embodiments of this aspect include corresponding computing systems, apparatus, and computer programs recorded on one or more computer storage devices, each configured to perform the actions of the methods.

Implementations may include one or more of the following features. The computing system where the dynamic attribute associated with an employee is defined by the organization. The data access language is used to access data from the OLAP database. The data access language is structured query language (SQL). The operations may include: storing new data received from a user of the organization in the document-oriented database; converting, using an automated extract, transform, and load (ETL) pipeline, the new data to converted data; and storing, using the object graph data structure, the converted data in the OLAP database. The document-oriented database is a NoSQL database. The OLAP database is a pinot database. The report is a job report based on the organizational data of the organization. The operations may include generating permission filters for the OLAP database based on user privileges of the user device. Implementations of the described techniques may include hardware, a method or process, or computer software on a computer-accessible medium.

One general aspect includes one or more tangible non-transitory computer-readable media storing computer-readable instructions that. The one or more tangible non-transitory computer-readable media storing computer-readable instructions also includes accessing a document-oriented database that stores the organizational data associated with the organization, where the organizational data may include an object graph data structure may include a plurality of data objects that respectively correspond to a plurality of employees of the organization, and where each data object includes a dynamic attribute is defined by the organization. The instructions also include accessing an OLAP database having a base table and a dimension table, the base table storing raw data associated with the data objects, and the dimension table storing lookup data associated with the dynamic attribute. The instructions also include receiving, from a user device, a user request for a report. The instructions also include generating, based on the object graph data stored in the document-oriented database, a first query being expressed in a custom query language, the first query being associated with a first data object from the plurality of data objects. The instructions also include retrieving, from the OLAP database, data from the base table based on the first query. The instructions also include joining, using the lookup data, the retrieved data with the data from the dimension table to generate the report. Other embodiments of this aspect include corresponding computer systems, apparatus, and computer programs recorded on one or more computer storage devices, each configured to perform the actions of the methods.

Other aspects of the present disclosure are directed to various systems, apparatuses, non-transitory computer-readable media, user interfaces, and devices for providing multilayered generation and processing of computer instructions. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a diagram of a document-oriented database having dynamic attributes, according to example embodiments of the present disclosure.

FIG. 2 depicts a diagram of an OLAP database having dynamic attributes, according to example embodiments of the present disclosure.

FIG. 3 depicts a high-level flow diagram of a write path in an OLAP database, according to example embodiments of the present disclosure.

FIG. 4 depicts a high-level flow diagram of a query path using an OLAP database, according to example embodiments of the present disclosure.

FIG. 5 depicts a flow diagram of an example method, according to example embodiments of the present disclosure.

FIG. 6 depicts a block diagram of an example of a computing device, according to example embodiments of the present disclosure.

FIG. 7 depicts an illustration of a graphical user interface, according to example embodiments of the present disclosure.

Reference numerals that are repeated across plural figures are intended to identify the same features in various implementations.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a further embodiment. Thus, it is intended that aspects of the present disclosure cover such modifications and variations.

The present disclosure relates to data processing systems, and more specifically to systems and methods for performing analytical queries on complex datasets. Some large-scale organizational management platforms may utilize document-oriented databases to handle transactional data. This approach, however, may introduce challenges for analytical reporting. For example, when a user generates a report that requires filtering or aggregating on dynamic, user-defined attributes, the system may parse large, unstructured or semi-structured data objects, such as JSON blobs, at query time. Such on-the-fly data extraction may be computationally intensive. This can result in high query latency and, in some cases, query timeouts, particularly for organizations with large datasets. This can create a tension between flexible data modeling and performant reporting. To address certain performance limitations, some existing systems employ a separate database, such as one optimized for online analytical processing (OLAP). This approach, however, may also introduce technical challenges. For instance, maintaining data consistency in real-time between transactional and analytical databases can be a complex process. The creation and maintenance of manual transformation scripts for each new data type can be time-consuming and may introduce opportunities for error, potentially leading to data latency and synchronization issues. Furthermore, some heterogeneous database architectures may present usability challenges to a user or to report-building tools. Formulating queries may require specialized knowledge of an underlying physical data structure, including relationships between different tables. This can make such systems more difficult to use and maintain.

Therefore, a need exists for systems and methods that can provide analytical reporting on complex data structures while addressing challenges related to performance, data consistency, and usability.

Disclosed systems and methods relate to a data processing and querying platform for analytical reporting on organizational data. An example platform can utilize a dual-database architecture, which may include a document-oriented database for transactional data management and a separate OLAP database for analytics. In response to a user request for a report, the system can generate a query, retrieve data from a base table in the OLAP database, and join it with a dimension table storing lookup data for dynamic, organization-defined attributes to generate the report. This architecture may provide a solution for querying multi-dimensional data within an organizational management platform.

Organizational management platforms that use document-oriented databases for online transaction processing (OLTP) may face technical challenges when performing complex analytical queries. These databases may store dynamic, customer-defined attributes in semi-structured formats (e.g., map or dictionary fields), which can be inefficient to query, aggregate, or use for grouping operations. Processing this data at query time can create performance bottlenecks, which may limit the ability to provide analytical reports on large datasets. Disclosed systems and methods may address these and other technical problems by providing an improved data processing and querying architecture.

In some implementations, an extract, transform, load (ETL) approach can reshape transactional data into a star schema within a dedicated OLAP database. Data from a document-oriented database, including records with dynamic attributes, can be streamed via a change data capture (CDC) pipeline. This data can then be transformed and materialized into two or more tables within the OLAP database, such as a base table for record data and a dimension table for flattened dynamic attributes. By pre-processing and structuring the dynamic attributes into a query-optimized format, the system can shift a portion of the computational burden from query time to ingestion time, which may facilitate faster joins and aggregations.

An example system may implement this approach through a set of components and processes. Upon receiving a report request, a platform can leverage an object graph data structure to generate a query expressed in a high-level query language. This query can then be translated into a standard data access language, such as SQL, to interact with the OLAP database. A resulting operation may retrieve data from the base table and perform a join with the dimension table to pivot the dynamic attributes for the final report. An automated ETL pipeline, which can be implemented using a stream processing framework, may be configured to maintain synchronization between the OLAP database and the transactional database. This type of integrated system may allow for the development of analytical reports, potentially resulting in improvements in query latency and system efficiency.

In various embodiments, a computing system may be configured to implement an organizational management platform for managing complex organizational data. The system may be configured to address technical challenges of performing analytical queries on data that may be natively stored in a flexible, document-oriented format suitable for transactional operations. The system may comprise one or more processors configured to execute instructions stored on non-transitory computer-readable media, a document-oriented database for OLTP, and a separate OLAP database that may be optimized for analytical reporting. This dual-database architecture, which may be bridged by an automated data processing pipeline, can enable the platform to offer both flexible data modeling for organizational management and analytical reporting, for example, on large and complex datasets with user-defined attributes. The system may address performance bottlenecks associated with querying semi-structured data at read-time by transforming and materializing the data into a query-optimized schema within the OLAP database.

The computing system may include a document-oriented database, which may be, for example, a NoSQL database. This database may serve as a repository for the organization’s transactional data and may store an object graph data structure that represents complex relationships within the organization. The object graph may comprise a plurality of data objects, where each data object can correspond to an entity within the organization, such as an employee, a department, or a role. An aspect of the data model can be its support for dynamic attributes. A dynamic attribute may be a data field that is defined by an organization, rather than being part of a fixed, predefined schema. For example, an organization’s administrator might define a custom attribute for employees such as a clothing size or a project identifier. In the document-oriented database, these dynamic attributes can be stored within a data object in a semi-structured or unstructured format, such as a map field, a dictionary field, or a JSON blob. While this can provide flexibility for transactional applications, it can present a technical challenge for analytics, as querying data within these nested or unstructured fields may involve computationally expensive parsing operations at query time.

To address the analytical limitations of the document-oriented database, the system may further comprise an OLAP database. The OLAP database, which in some embodiments may be a columnar database, may be configured for high-speed, low-latency analytical queries over large datasets. Within the OLAP database, the organizational data may be structured according to a star schema, which can include at least a base table and a dimension table. The base table, also referred to as a fact table, can store raw data or core records associated with the data objects from the document-oriented database. For instance, a row in the base table might contain primary information for a specific employee record. The dimension table, in contrast, may be configured to store lookup data specifically associated with the dynamic attributes. Instead of a JSON blob, the dynamic attribute data may be flattened and stored in a structured format, for example, with columns for a parent object identifier, an attribute name or key, and an attribute value. In some embodiments, the dimension table may include separate columns for different value data types (e.g., valueString, valueDouble) to further optimize storage and querying. This star schema architecture can separate the core data from the multi-dimensional attribute data, enabling efficient join operations for analytical reporting.

The system may further include one or more non-transitory computer-readable media that collectively store instructions for performing operations on the platform. These operations may begin when the system receives a user request for a report, for instance, from a user device (e.g., a personal computer, a smartphone, a tablet, a wearable computing device, etc.) interacting with an interface of the organizational management platform. The user request may specify various filters, groupings, and projections, including those that rely on the dynamic attributes defined by the organization. In response, the system may generate a first query based on the object graph data structure. This first query may be expressed in a custom query language. This custom language can provide a high-level abstraction over the physical database schema, allowing queries to be formulated based on logical relationships within the object graph, such as an employee’s relationship to their department or their custom attributes. This abstraction can shield a user or a report-building application from the complexity of the underlying OLAP star schema, which may improve system usability and maintainability.

Once the first query is generated in the custom query language, the system can translate it into a data access language suitable for execution against the OLAP database, such as Structured Query Language (SQL). This translation process can be an aspect of the system’s operation, as it may convert the high-level, object-oriented query into a specific, optimized set of SQL commands. The generated SQL query can be configured to first retrieve relevant raw data from the base table in the OLAP database based on the criteria of the user’s report request. A subsequent step in the operation may be joining the retrieved data with data from the dimension table. This join operation can use the lookup data stored in the dimension table, which may contain the flattened dynamic attribute information. For example, the SQL query may perform one or more LEFT JOIN operations to link each record from the base table with its corresponding dynamic attributes in the dimension table. As part of this process, the query can pivot the row-based attribute data from the dimension table into columns in the final result set, presenting the dynamic attributes as if they were native fields of the original data objects. This joined and pivoted data can then be used to generate the final report, which may be subsequently transmitted back to the user device for display.

To maintain data consistency and freshness between the document-oriented database and the OLAP database, the system’s operations may further include implementing an automated ETL pipeline. This pipeline may operate in a streaming, near real-time fashion. When new data is received from a user and stored in the document-oriented database, a CDC mechanism may be triggered. In some embodiments, this may involve capturing database operation logs and publishing them as events to a message queue, such as a message queue topic. A stream processing framework may consume these events from the message queue. The ETL pipeline may then execute a configurable transformation logic on this data. This transformation may include parsing the CDC messages, extracting the key-value pairs from dynamic attribute fields (e.g., a map field), and flattening any nested or semi-structured data into a relational format suitable for the OLAP dimension table. This process may also involve enriching the data by looking up metadata, such as the data type of a dynamic attribute, from an external cache that stores information from the object graph. Finally, the transformed data may be loaded into the OLAP database, with core record data populating the base table and the structured dynamic attribute data populating the dimension table. This automated pipeline may facilitate continuous and efficient updates to the analytical data store without requiring manual intervention, thereby providing a scalable solution for real-time reporting on dynamic organizational data.

The system’s architecture may also incorporate security and permissioning. When generating a report, the operations may further include generating and applying permission filters for the queries executed against the OLAP database. These filters may be generated based on user privileges associated with the user device or the user account initiating the report request. For example, in an HR management platform, a departmental manager may only have permission to view data for employees within their specific department. The system may enforce this by dynamically adding a WHERE clause or an equivalent filter to the SQL query, such that the report generated and returned to the user only contains data that the user is authorized to access. This integration of a platform’s permission model into the analytical querying process can provide a technical benefit by enabling secure, role-based reporting while still leveraging the performance of the OLAP database. The reports generated by the system can vary widely, for example, from a job report detailing employee roles and tenures across the organization, to a payroll report aggregating compensation data, or a time and attendance report. In each case, the system’s configuration for querying both standard and dynamic attributes can allow for the creation of customized and performant analytical reports that can meet diverse needs of a large organization.

An example technical problem solved by example implementations of aspects of the present disclosure may include the inefficient processing of analytical queries on organizational data platforms. Some platforms may utilize document-oriented databases for OLTP because of their flexibility in handling varied data structures. However, these databases may store complex, user-defined data, for instance custom employee attributes in an HR system, in unstructured or semi-structured formats such as JSON objects within a general-purpose field. When generating analytical reports that involve filtering, aggregating, and projecting these custom attributes, a system may need to parse these large objects at query time. This on-the-fly data extraction and transformation can be computationally expensive, leading to high query latency and a reduced ability to scale as data volume and query complexity increase. This inefficiency can result in query timeouts, which may degrade the user experience and reduce the reliability of the platform’s analytical reporting features for large organizations.

Example implementations of aspects of the present disclosure may provide technical solutions to this problem by implementing a hybrid database architecture that can optimize data for analytical queries. A system may utilize an OLAP database, for example a columnar database, which can be designed for low-latency analytical queries. Instead of storing dynamic attributes in an unstructured format, the data can be pre-processed and stored in a structured star schema within the OLAP database, which may comprise a base table for record data and a separate dimension table for lookup data associated with the dynamic attributes. When a user requests a report, a first query expressed in a custom query language may be generated based on an object graph of the organization. This query can then be translated to a data access language, such as SQL, to retrieve data by joining the base table with the structured dimension table. This approach may offload the computationally intensive task of parsing and transforming the dynamic attribute data from query time to an automated ingestion pipeline. A resulting technical effect may be a reduction in query execution time and improved system performance, allowing the platform to serve complex analytical reports over large and dynamic organizational datasets with greater effectiveness.

Another example technical problem solved by example implementations of aspects of the present disclosure may include the complexity and potential for unreliability in maintaining data consistency between transactional and analytical databases in a real-time organizational management platform. For an analytical database to be effective, its data may need to be a recent and accurate representation of the data in the primary transactional database. When dealing with dynamic, user-defined attributes, this synchronization can be difficult. A simple replication might copy unstructured data blobs, which may not solve the query performance problem. Conversely, creating and maintaining manual transformation scripts for each type of dynamic attribute can be an error-prone, time-consuming, and unscalable development process that may not efficiently handle real-time data changes captured from the transactional database. This can result in data latency, inconsistencies, and a high maintenance overhead for the platform’s data infrastructure.

Example implementations of aspects of the present disclosure may provide technical solutions to this problem by utilizing an automated, streaming extract, transform, and load (ETL) pipeline. This pipeline may leverage a stream processing framework to consume Change Data Capture (CDC) records from the document-oriented database in real-time. The system can employ a configurable transformation logic that processes these records. It may extract key-value pairs from dynamic attribute fields, flatten unstructured or nested data, and enrich it by fetching metadata, such as data type information, from an external source like an object graph cache. This transformed, structured data can then be loaded into the dimension table of the OLAP database. A technical effect of this automated ETL pipeline can be the creation of a low-latency and scalable mechanism for synchronizing and structuring data for analytical purposes. This may improve data integrity and consistency across the platform’s heterogeneous database systems while reducing the manual development and maintenance effort that may be required to support new dynamic data types.

Another example technical problem solved by example implementations of aspects of the present disclosure may include the difficulty for users in formulating efficient and accurate queries for custom reports in a platform utilizing a heterogeneous database architecture. When organizational data is split between a document-oriented OLTP database and a structured OLAP database using a star schema (e.g., with base and dimension tables), users or report-building tools may need knowledge of this underlying physical data structure. Formulating a query to report on dynamic attributes can require writing complex SQL involving multiple join operations to link the base table with the dimension table and pivot row-based attribute data into columns. This process can be complex, may require specialized database expertise, can be prone to formulation errors, and can tightly couple the reporting application with the database schema, making the system less straightforward to use and maintain.

Example implementations of aspects of the present disclosure may provide technical solutions to this problem by providing a high-level query abstraction layer. The system can use a custom query language that reflects the logical structure of the organizational data, for instance as defined by an object graph, rather than the physical storage schema of the OLAP database. When a user requests a report including a dynamic attribute, the system can translate a declarative query expressed in this custom language into the corresponding complex SQL query for execution against the OLAP database. This translation process can be configured to generate the appropriate join and pivot operations between the base and dimension tables. A technical effect of this abstraction can be a simplification of the query formulation process, which may make the reporting feature more accessible for users without specialized database expertise. This decoupling of the logical data model from the physical storage model can enhance the platform’s usability and maintainability by shielding the application layer from complexities of the underlying database architecture.

This invention relates to a system and method for processing, materializing, and querying multi-dimensional data at scale, specifically designed to optimize analytical query performance on dynamic attributes derived from transactional systems. The system employs an automated extract, transform, and load (ETL) pipeline that flattens and materializes nested data structures into a star schema, leveraging streaming frameworks like a stream processor (e.g., using Apache Flink) and real-time, distributed OLAP database (e.g., Apache Pinot), with integration into federated query engines for seamless data consumption.

The invention relates to systems and method for handling dynamic attributes in large-scale analytics. For example, an organization can utilize a document-oriented database (e.g., MongoDB) to store their organizational data for fast product development. However, as the data grows to a large scale (e.g., millions of data objects), the query performance degrades, in part because of the issues with nested data structures.

According to some embodiments, the system can include an ETL system for converting the data from the document-oriented database to an OLAP database. For example, the system subscribes to changes in the document-oriented database, unnests data, and writes it to a star schema. The system can use a metadata store, such as an object graph, to determine data types and optimizes query efficiency. The invention includes novel components like a stream processor (e.g., using Apache Flink) and a dynamic attribute query pattern.

As discussed herein, due to the limitations of the document-oriented database for large-scale analytics, the invention includes an ETL system to convert data into an OLAP-oriented data store. The invention addresses the challenge of converting nested data into a format ingestible into OLAP data stores. For example, payroll data initially stored can the document-oriented database can be converted stored in the OLAP datastore. For example, the system can subscribe to document-oriented changes in real-time, unnests the data, and writes it to a star schema in OLAP database, with a schema registry for metadata. Additionally, the system can also implement a pattern in the custom query language to query dynamic attributes more efficiently.

The object graph can be utilized as a metadata store for data types, which is used to store data in the destination table. For example, the object graph can be utilized by the system to determine whether the data extracted from the document-oriented should be stored in the base table or in the dimension table. For example, data that is available in the object graph, such as employee identifier can be stored in the base table, the dynamic attributes can be stored in the dimension table. The dynamic attributes are obtained from the specific organization and can defer between different organizations.

Additionally, the read function from the OLAP database utilizes a custom query language and the construction of special Structured Query Language (SQL) for the dynamic attributes.

In some instances, the system has two databases. The first database is a document-oriented database that is schema-lass and more document oriented. The second database can be a Relational Database Management System (RDBMS) that organizes data into structured tables where the schema is quasi-fixed. For example, the second database can be an OLAP database. The second database has better query efficiency, especially for generating reports associated with a large amount (e.g., more than a million data entries). For example, generating such reports with the first database by scanning millions of rows and then running an aggregation could result in performance issues, such as delays in generating the report or the system timing out. Therefore, it may be inefficient to build an analytics product on top of the first database.

According to some embodiments of the present invention, the system includes an ETL component that obtains the documents stored in the first database, converts them into rows and ingests them into an OLAP oriented data store. The OLAP database can be a data store that is columnar in its format and not document oriented. The system does not need to define the schema ahead of time, and the schema can be generated in real-time during the ingestion process. Additionally, the system can perform optimization processes so that the data can quickly be fetched from the second database. For example, the system can perform queries that fetch, and scan millions of rows based on certain predicates, fetches that data and performs aggregation on top of the fetched data. This type of query may not have been possible with the first database. Additionally, because the data modeling of the first database is nested, the data from the first database cannot be easily converted to be readily ingestible into these OLAP data stores.

For example, with regards to payroll data, the data can include a large number of dynamic attributes that are defined by the organization (e.g., customer). Given that there are dynamic attributes that are defined by the customer, the system cannot design a schema that fits a payroll product. To illustrate, the system cannot have a fixed set of fields and expects that design to serve the payroll requirements in different jurisdictions because different jurisdictions have different tax attributes, earnings attributes, reduction attributes, and so on. The system has an underlying schema that handles all of these different dynamic attributes, while still being able to query the dynamic attributes. For example, an organization management platform can have thousands of different payroll attributes because the organizations operate in many jurisdictions, with each jurisdiction having slightly different payroll attributes. The system cannot define a table with thousands of columns in your OLAP data store. As a result, the system has been designed to handle a varying number of dynamic attributes which are specific to the use case and to a specific customer.

Various product uses dynamic attributes in their document-oriented models. When streaming these tables to OLAP database, the system serialized the dynamic attributes as Json fields, making it impossible to write complex queries against these attributes that can be fast and support operations like grouping, aggregations, and flattening of the nested data. Hence these models may not be by the custom query language currently for critical use-case like reports. The system introduces a data transformation platform that solves this schema reconciliation problem between document-oriented and the OLAP database.

The system can use document-oriented for OLTP (transactional queries) and OLAP database for real-time customer facing OLAP (analytical queries). The system handles the processing and materialization of this multi-dimensional data in the OLAP database along with providing a performant way for teams across the platform to query this data via a custom query language. The system allows users to utilize the platform capability without worrying about modeling their data to fit both DBs and being agnostic to the details of the data stack.

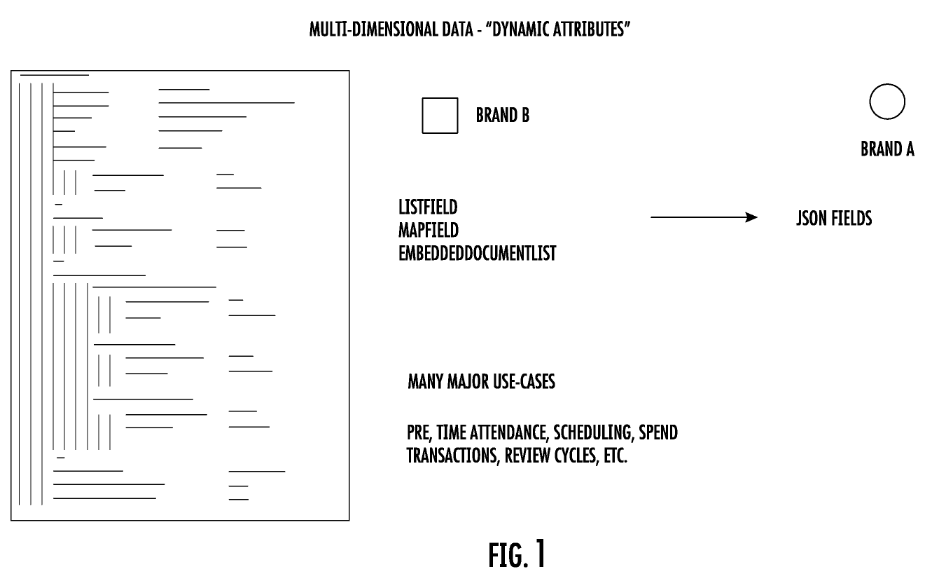

As illustrated in FIG. 1, various systems use dynamic attributes in their document-oriented models - MapField, DictField or ListFields. As described above, when streaming these tables to OLAP database they are serialized as json fields, making it impossible to write complex queries against these attributes that can be fast and support operations like grouping, aggregations, and flattening of the nested data. Even for small result sizes, the execution time is roughly similar to the ELT route that reports were using where they would parse the json in python application code. As the row count in the query results go up, this approach may not work and the query eventually times out.

For direct-to-OLAP database query, OLAP database nodes may not handle beyond a predetermined threshold of data (e.g., 50k rows). Direct-to-OLAP database queries are being discussed here in case the system moves to OLAP database in the future directly once multi-stage engine that allows x-table joins.

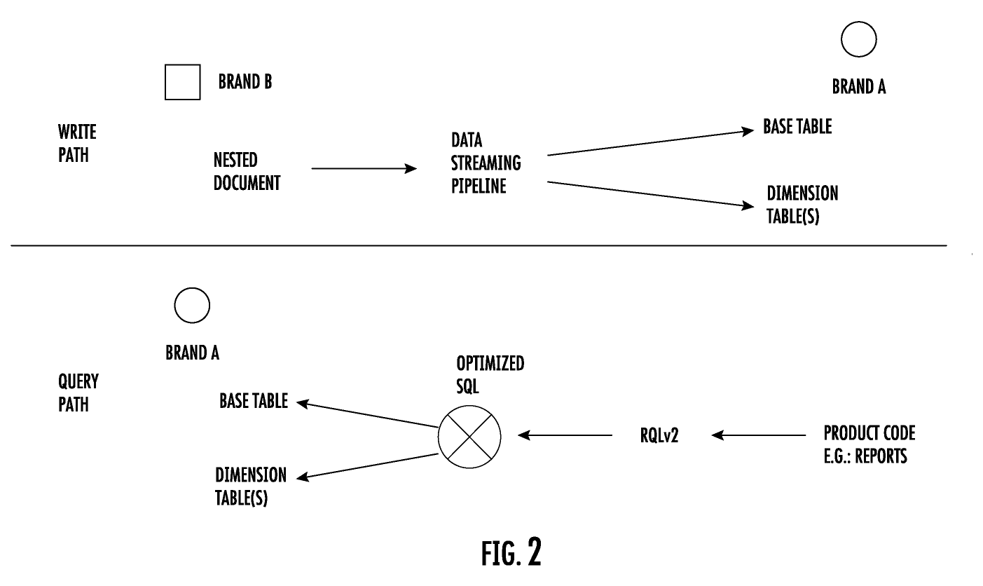

According to some embodiments of the present invention, the system can store the data in an OLAP database as shown in FIG. 2. In a star schema, the data can be divided into base tables coupled with many related dimension tables. At query time, the system joins across these tables to get the results.

The system to implement can consist of the following features. The features can include automated creation of relevant tables in OLAP database to store dynamic attributes related to a specific document-oriented model. Additionally, the features can include automated ETL pipeline creation to extract dynamic attributes from document-oriented CDC records, transform and load them into appropriate OLAP database tables. Moreover, the features can include support in custom query language to query these dynamic attributes.

Furthermore, the features can include a star schema (e.g., flattening out dynamic attributes into a different table). The system can materialize all the flattened json attributes on a new table. In the schema, the system defines a column for each possible datatype of the attribute. So, if the attribute is of type String or Double its value gets written to the column name valueString or valueDouble, respectively. This makes the schema versatile enough to store any attribute information. It is also possible to make any aggregations on this resulting dataset which the report’s product needs, for obvious performance gains.

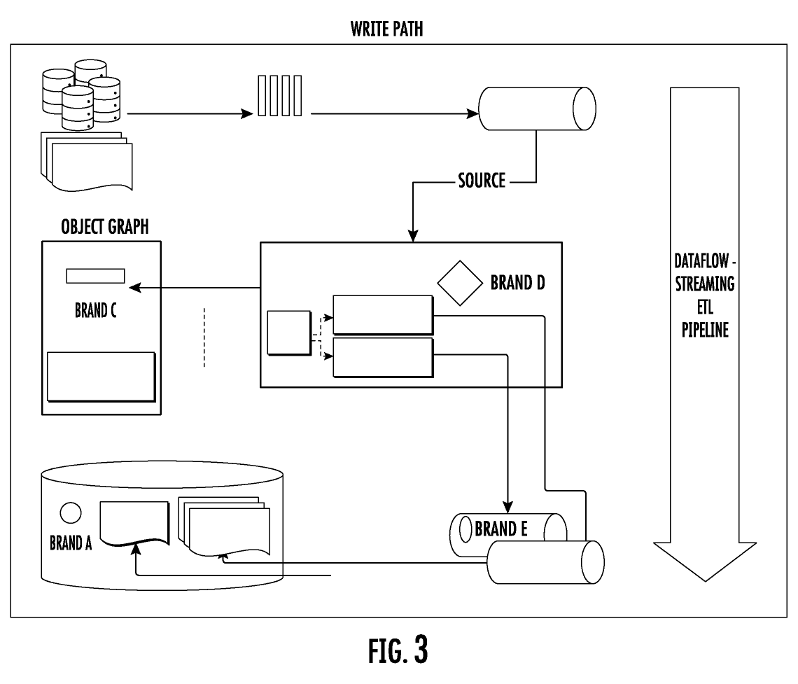

FIG. 3 illustrates a write path using a CDC (Change Data Capture) Pipeline according to example embodiments of the present invention.

In order to keep document-oriented and OLAP database in sync, the system can create corresponding OLAP database tables for each document-oriented collection, which have to ‘onboard’ to OLAP database. Once onboarded, a pipeline is created where document-oriented-CDC events being written to Kafka topics in real-time from which OLAP database ingests. This is just ‘E+L’ part of the canonical ETL pipeline. There are technically some transformations done at the document-oriented CDC layer in the form of appending additional information to the raw document-oriented op-log to make it easy to use the message for performing updates in OLAP database.

At the OLAP database ingest layer, these messages from Kafka are then transformed and upserted into the relevant OLAP database table based on the row Id and the updated column values.

The system can create child tables to materialize multi-dimensional data (e.g., dynamic attributes). This is where a stream processing component comes in, that reads the CDC kafka topic messages and extracts these attributes into their own records, so that the attributes can be ingested into the new materialized table. The above diagram represents the new components that perform this operation in green. The system picked Apache Flink as our stream processing framework.

The messages in this topic are ingested by an OLAP database table which is designated as the dynamic attributes table for that particular model. A Flink job is capable of having multiple dataflow graphs in parallel as it scales the reader, transforms, and write tasks independently as per the need. The Task Manager is able to co-ordinate across them all to ensure ordered and partitioned processing of the messages across the reader, transform, and write dataflow graph.

The system deploys a different app in the cloud cluster per model; the underlying transformation code is exactly the same across the models.

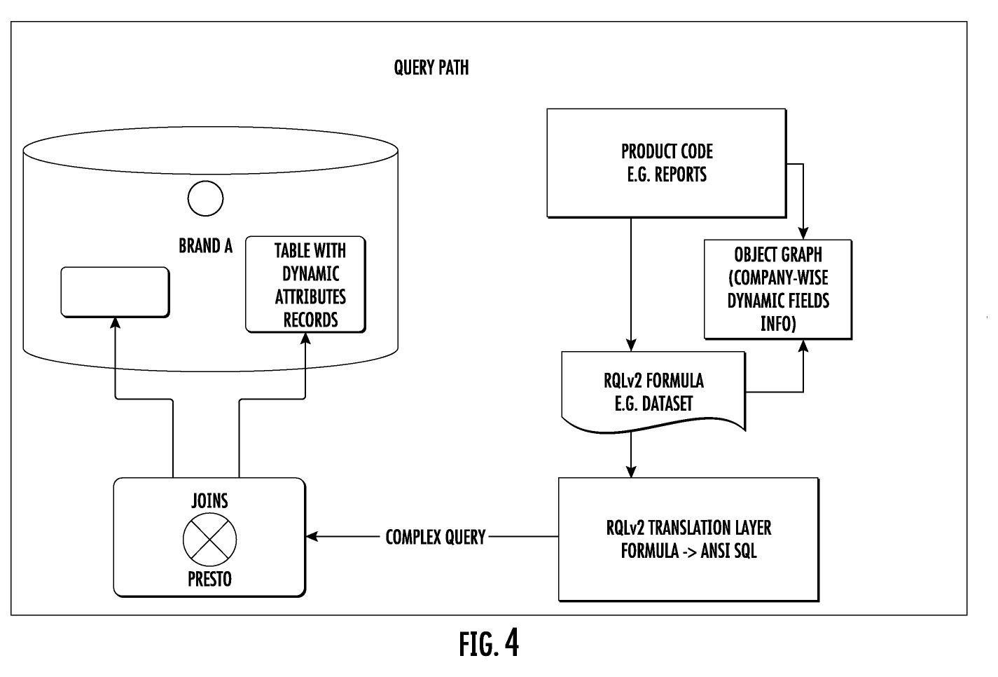

FIG. 4 illustrates a read path using an RQL formula construction and translation according to example embodiments of the present invention.

RQL introduced a Dataset function to let product teams have the ability to query a dataset without writing full-blown SQL. For the reports product a slightly specialized version of the Dataset function called ReportsDataset was introduced. The grammar, syntax and RQL->SQL translation logic of both ReportsDataset and Dataset are exactly the same. Here’s a very basic illustrative example of a ReportsDataset query that could be created from a Time & Attendance report run by an end-user. In the ReportsDataset function syntax, the FROM() clause specifies the models (tables) from which data is to be fetched and the GROUPABLE_COLUMNS()clause contains the individual fields (columns) from that table to be selected. In the above example, TimeAttendanceReportsMaterializationCache is the underlying document-oriented model for T&A reports, with dynamic attributes stored in a map field called dimension_choice_by_dimension_id on that model. In the Reports product user interface, the end user will select this attribute ‘1234’ from the Time & Attendance category of attributes much like some of the other native fields on that model like checkDate or shiftStart and add it to the report. Hence, the product teams can treat such attributes as if they were defined as the top level fields on the model itself.

Then in the next step, the resulting ReportsDataset RQL formula would translate this attribute into a special format created for representing dynamic attributes. This format is implemented in and supported in the object graph. To support this object graph introduced the concept of ‘static’ vs ‘dynamic’ part of the object graph for a given company per model.

This above query joins the data between the base and the child tables, fetching the dynamic attributes stored individually row-wise and then pivots them into columns for the final result of the query. The pivot step allows the attributes to be displayed as columns in the final report, appearing to the end user as if these attributes were top level fields on whatever model’s data they’re reporting on. The pipeline optimization operations ensure that the streaming ETL pipeline is reliable, fault tolerant and ready for prime time.

The system has implemented periodic ETAs to spot check data correctness between the base and child OLAP database tables per model. These data correctness checks run every predetermined hours for entities by data size for that model and ensure that for every record belonging to that company, the data is accurate. The system has a retool app that can trigger ETA to run data parity checks between the two tables. These can be run per company, or for a specific set of record ids. This gives confidence that the pipelines are processing the data correctly and that the ingestion is also robust. The retool is also helpful in investigating any issues in specific records especially in case of incidents.

Since the system can write to multiple table in the star schema, it is important to ensure that the tables are in sync or the join at query time will return inconsistent results. The live traffic coming from document-oriented CDC is low enough per model, so that the streaming ETL pipeline as well as the OLAP database ingestion layer should be easily able to handle the volume. The system expects table to be ingesting the records near simultaneously.

Generally, the present disclosure is directed at providing improved computer applications, computer systems, computer-implemented methods, user interfaces, and/or services for automated report generation using custom computer language and optimized data retrieval techniques. For example, the system allows users to query, interact with, and/or perform various tasks associated with organizational data stored in an organizational data management system.

The system described herein can utilize an analytics engine that is tuned to support real time queries. In some instances, as large customers are onboarding on an organization data management system, the volume of organization data can grow exponentially, which may result in delays in data retrieval or automatic report generation. For example, the system may encounter issues with tail latencies, which can be amplified as the system generates a plurality of reports on a unified dashboard for a user.

According to some embodiments, the system utilizes a novel architecture that can support reporting millions of data points in seconds, which can optimize reports generation with growing data and also reduce tail latencies.

The systems, methods, and computer program products described herein provide a number of technical effects and benefits. As one example, the embodiments described in the present disclosure provide automated generation and processing of computer instructions for use across a variety of applications and systems that utilize different underlying technologies and technical designs, for example, more efficiently and with fewer computing resources (e.g., less processing power, less memory usage, less power consumption, etc.), that would otherwise be wasted by maintaining custom, proprietary, and/or manual processes. In particular, examples of the present disclosure automate the generation and processing of computer instructions across different applications and systems using a rigorous computerized process.

Additionally, the techniques described herein reduce the network bandwidth requirement to generate a report. For example, by combining the different queries into a unified query, the system can retrieve data from one or more databases during a single operation, in contrast to conventional systems when the data is retrieved for each query and then manipulated to generate the report. As a result, the amount of data retrieved in a conventional system for generating the same report can be much larger than with the system described herein. For example, with the novel architecture described herein, by increasing the number of SQL operations that are aggregated and unified, it reduces the amount of raw data that needs to be serialized and transferred between the SQL query engine and the OLAP engine, resulting in a more efficient query.

With reference to the Figures, example embodiments of the present disclosure will be discussed in further detail.

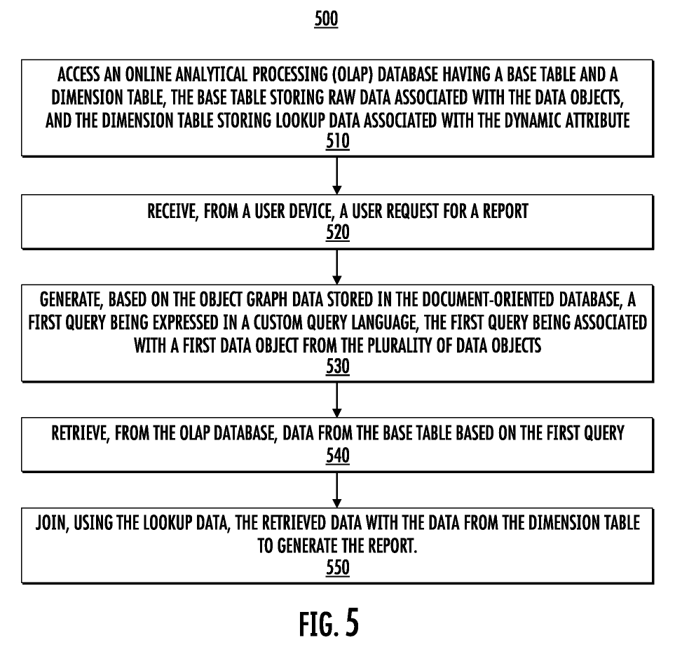

FIG. 5 illustrates an example flow diagram 500 according to some embodiments of the present invention.

At 510, the system can access a document-oriented database that stores the organizational data associated with the organization, wherein the organizational data comprises an object graph data structure comprising a plurality of data objects that respectively correspond to a plurality of employees of the organization, and wherein each data object includes a dynamic attribute is defined by the organization.

In some examples, the system includes a specific ETL process where nested/dynamic fields (e.g., MapField, DictField) from the document store are flattened or exploded into a separate table. In this table, dynamic attributes are stored as individual rows (vertical representation) rather than columns, enabling efficient joins and avoiding JSON parsing at query time. The dimension table storing lookup data associated with the dynamic attribute and joining using the lookup data can include a relational lookup (e.g., joining a static ID to a name) and also a lookup associated with transforming dynamic, nested document structures into a vertical key-value schema to optimize OLAP performance.

In some examples, the system can include a stream processing step (e.g., using Flink) that consults an external metadata source (Object Graph/Redis) to determine the specific data type of a dynamic attribute. This allows the system to route the value to a specific typed column (e.g., valueString, valueDouble) within the rigid schema of the OLAP database. The system can fetch metadata from the object graph data structure during the ETL transformation to map dynamic values to strongly typed columns in the destination table.

At 510, the system can access an OLAP database having a base table and a dimension table, the base table storing raw data associated with the data objects, and the dimension table storing lookup data associated with the dynamic attribute.

At 520, the system receives, from a user device, a user request for a report.

At 530, the system can generate, based on the object graph data stored in the document-oriented database, a first query being expressed in a custom query language, the first query being associated with a first data object from the plurality of data objects.

At 540, the system can retrieve, from the OLAP database, data from the base table based on the first query.

At 550, the system can join, using the lookup data, the retrieved data with the data from the dimension table to generate the report.

In some examples, the system includes a specific query translation logic where the custom query (RQL) is translated into SQL that uses Common Table Expressions (CTEs) or multiple joins to pivot the vertical attribute rows back into a horizontal column format for the final report. The system can capture the specific pivoting logic required to reconstruct the dynamic attributes from the flattened dimension table into a usable report format in order to join the data to generate the report.

In some instances, the dynamic attribute associated with an employee is defined by the organization.

In some instances, the custom query language is converted to a data access language, and wherein the data access language is used to access data from the OLAP database.

In some instances, the data access language is Structured query language (SQL).

In some instances, the system can store new data received from a user of the organization in the document-oriented database. Additionally, the system can convert, using an automated ETL pipeline, the new data to converted data. Moreover, the system can store, using the object graph data structure, the converted data in the OLAP database. In some examples, the system can include a real-time architecture utilizing Change Data Capture (CDC) logs from the source database, published to a message queue (Kafka), and processed by a stream processor (Flink) to update the OLAP database (e.g., OLAP store) in real-time. The automated ETL pipeline can be a streaming or real-time process based on CDC events to enable an optimization for real-time analytics.

In some instances, the document-oriented database is a NoSQL database.

In some instances, the OLAP database is an OLAP store.

In some instances, the report is a job report based on the organizational data of the organization.

In some instances, the system can generate permission filters for the OLAP database based on user privileges of the user device.

In a first working example, a system is configured to provide analytical reporting for a payroll management module within a large-scale organizational platform. The platform can utilize a document-oriented database for managing transactional payroll data, such as individual paychecks and employee compensation details. A data object, representing a payroll record, can include a dictionary field, for example, named items. This field may store dynamic, organization-defined earnings and deduction types as key-value pairs (e.g., “Bonus”: 500.00, “Commuting_Allowance”: 75.50). The system can also include an OLAP database.

In an initial configuration, to generate a report that includes these dynamic attributes, the platform streams payroll data into a single table in the OLAP database, where the items field is stored as a JSON string. When a user requests a report to aggregate “Bonus” payments, the system generates a SQL query that uses a function to parse the JSON string for each row in the table at query time. In benchmark tests with this configuration, a query retrieving 10 dynamic attributes from 40,000 rows may exceed 7 seconds to execute. For a query involving 60,000 rows, the operation may not be complete and can result in a query timeout. This configuration can exhibit high latency and limited scalability when performing analytics on semi-structured data at read time.

To address this technical challenge, the system can be reconfigured. An automated, streaming ETL pipeline may be implemented using a stream processing framework. This pipeline can consume Change Data Capture (CDC) events from the document-oriented database. For each payroll record, the pipeline can process the items dictionary field. It can flatten the key-value data, creating structured records that are loaded into a dimension table in the OLAP database. The dimension table can have a schema including columns such as parent_record_id, attributeName, valueString, and valueDouble. For a payroll record with an items field containing “Bonus”: 500.00, the ETL pipeline can generate a corresponding row in the dimension table with the values: parent_record_id, “Bonus”, and 500.00 in the valueDouble column. The primary, non-dynamic data for the payroll record can be loaded into a separate base table in the OLAP database.

With this configuration, when the user requests the report aggregating “Bonus” payments, the system can generate a high-level query in a custom query language that logically references the “Bonus” attribute. The system can translate this query into an optimized SQL query. The translated SQL query can perform a LEFT JOIN operation between the base table and the dimension table, filtering the dimension table for rows where the attributeName is “Bonus”. This join operation may be performed efficiently because the data is pre-structured and indexed within the OLAP database. A technical effect may be an improvement in query performance. Benchmark comparisons can show that p99 query latencies are reduced by a factor of 4 to 5 across a range of similar reports. Queries that previously timed out on datasets of 60,000 rows may be completed in seconds, which can facilitate scalable analytical reporting for the user.

In a second working example, a system can be implemented to support analytical reporting for a time and attendance module. The platform’s document-oriented database can store employee time-tracking data in a collection where each document includes a field containing a list of embedded documents. This field can contain a list of nested objects, with each object representing a time entry with dynamic attributes, such as “Project_Code” or “Task_Type,” that are defined by the organization. Generating a report that summarizes hours worked per “Project_Code” may involve iterating through this list of nested objects for each employee time record, which can be computationally intensive.

To address this, the system’s ETL pipeline can be configured to process streaming CDC events for the time-track collection. The stream processing job can iterate through each item in the list field for each updated record. For each nested object, the pipeline can extract the dynamic attribute data (e.g., “Project_Code”: “Project_X”) and create a flattened, structured record for the dimension table in the OLAP database. This structured record can link the parent time-tracking record ID to the attribute name (“Project_Code”) and its value (“Project_X”).

When a user requests a report summarizing hours by project code, the system can generate a query in its custom query language. The query can be translated into an optimized SQL statement that joins the base time-tracking data table with the dynamic attribute dimension table. This query can then efficiently filter and group by the attributeName and valueString columns in the dimension table to aggregate the total hours per project code. This architecture can facilitate an efficient analytical query for an operation that may otherwise be unperformant on a scale. A technical effect is that the system can provide interactive dashboards and reports on dynamic, multi-dimensional time and attendance data. This may improve the analytical capabilities of the organizational management platform.

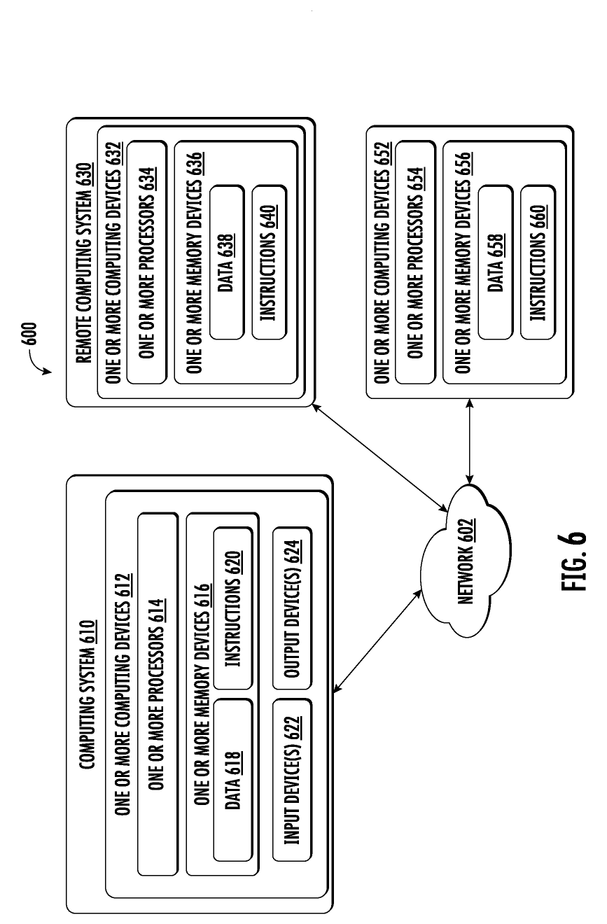

FIG. 6 depicts a block diagram of an example environment 600 including a computing system 610 that performs operations according to example embodiments of the present disclosure. The environment 600 includes a network 602, a computing system 610, one or more computing devices 612, one or more processors 614, one or more memory devices 616, data 618, instructions 620, a remote computing system 630, one or more computing devices 632, one or more processors 634, one or more memory devices 636, data 638, instructions 640, one or more computing devices 652, one or more processors 654, one or more memory devices 656, data 658, and instructions 660.

The network 602 can include any type of communications network. For example, the network 602 can include a local area network (LAN), a wide area network (WAN), an intranet, an extranet, and/or the internet. Further, the network 602 can include any number of wired or wireless connections and/or links that can be used to communicate with one or more computing systems (e.g., the computing system 610 and/or the remote computing system 630) and/or one or more devices (e.g., the one or more computing devices 652). Communication over the network 602 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 610 can include any combination of systems and/or devices including one or more computing systems (not shown) and/or one or more computing devices 612. Further, the computing system 610 may be connected (e.g., networked) to one or more computing systems (e.g., remote computing system 630) and/or one or more computing devices (e.g., one or more computing devices 632, 652) via the network 602. The computing system 610 may operate in various different configurations including as a server or a client machine in a client-server network environment, or as a peer-to-peer (or distributed) network environment. Though the computing system 610 is depicted in FIG. 6 as a single device, the computing system 610 can include any collection or combination of devices that individually or in combination with other devices, execute a set of one or more instructions to perform any one or more of the operations discussed herein.

In this example, the computing system 610 includes the one or more computing devices 612. The one or more computing devices 612 can include any type of computing device. For example, the one or more computing devices 612 can include a personal computing device (e.g., a desktop computing device), a mobile computing device (e.g., a smartphone or tablet device), a wearable computing device (e.g., a smartwatch device), an embedded computing device, a web appliance, a server computing device, a network router, a switch, a bridge, or any device capable of executing a set of instructions (e.g., any combination of instructions which can include sequential instructions and/or parallel instructions) associated with one or more operations and/or one or more actions to be performed by the computing system 610 or any of the constituent components and/or devices of the computing system 610.

Any of the one or more computing devices 612 can include the one or more processors 614. The one or more processors 614 can include any processing device (e.g., a processor core, a microprocessor, an ASIC, a FPGA, a controller, or a microcontroller) and can include one processor or multiple processors that may be operatively connected. In some embodiments, the one or more processors 614 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 612 can include the one or more memory devices 616. The one or more memory devices 616 can be used to store data and/or information and can include one or more computer-readable media, one or more non-transitory computer-readable storage media, and/or one or more machine-readable media. Though the one or more memory devices 616 are depicted in FIG. 6 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 616 can include any combination of random-access memory (RAM), read-only memory (ROM), EEPROM, EPROM, one or more flash memory devices, and/or one or more magnetic storage devices (e.g., one or more hard disk drives).

The one or more processors 614 can be configured to execute one or more instructions to perform the operations described herein including, for example, one or more operations associated with performing multilayered generation and processing of computer instructions in association with a custom query language (e.g., a custom query language for use with organizational data) across various types of applications and/or computer systems. Further, the one or more memory devices 616 can store the data 618 and/or the instructions 620, which can be executed by the one or more processors 614 to cause the one or more computing devices 612 to perform one or more operations. For example, the one or more operations performed by the one or more processors 614 can include receiving a request comprising one or more instructions in a first computer language, parsing the one or more instructions in the first computer language in view of one or more rules associated with the first computer language, analyzing the one or more instructions in the first computer language in view of information describing structure of a first application, generating one or more instructions in a second computer language different from the first computer language with the one or more instructions in the second computer language being generated based on the one or more instructions in the first computer language and the information describing structure of the first application, obtaining a result from a second application where the result comprises information based on the one or more generated instructions in the second computing language, and providing the result in response to the request comprising the one or more instructions in the first computer language, etc.

The data 618 can include organizational data (e.g., organizational data that can include one or more organizational records), one or more data structures defining, describing, and/or otherwise associated with the organizational data, rule data (e.g., rule data that includes one or more rules used to configure an application policy, one or more rules maintained by or otherwise associated with an organizational data management system, etc.), application data (e.g., application data associated with a plurality of applications including one or more third-party applications and/or one or more intra-organizational applications), third-party integration data (e.g., data providing configuration and/or other information for performing integration and synchronization with each of one or more different third-party systems and/or applications), organizational policy data (e.g., organizational policy data associated with one or more organizational policies), application policy data (e.g., policy data that includes one or policies associated with the organizational data, the rule data, the application data, one or more applications, one or more devices, etc.), data that includes instructions in a custom computer language (e.g., a custom query language based on organizational data), data that includes rules associated with the custom computer language, and/or other types of data. Further, the instructions 620 can include one or more instructions to use data including the data 618 to perform any one or more of the various operations described herein. In some embodiments, the one or more memory devices 616 can be used to store one or more applications that can be operated by the one or more processors 614. The data 618, the instructions 620, and/or the one or more applications can be associated with an organization. Further, the computing system 610 may be associated with an organization and may be configured to manage the one or more applications. For example, the computing system 610 can perform one or more operations associated with authenticating one or more users that attempt to access the one or more applications which can include one or more third-party applications, which may be remote from the computing system 610.

Any of the one or more computing devices 612 can include one or more input devices 622 and/or one or more output devices 624. The one or more input devices 622 can be configured to receive input (e.g., user input) and can include one or more touch screens, one or more keyboards, one or more pointing devices, (e.g., mouse device), one or more buttons, one or more microphones, and/or one or more cameras. The one or more output devices 624 can include one or more display devices, one or more loudspeaker devices, one or more haptic output devices. By way of example, the one or more output devices 624 can be used to display a graphical user interface via a display device that can include a touch screen layer that is configured to detect one or more inputs (e.g., one or more user inputs). The one or more processors 614 may perform one or more operations (e.g., operations associated with performing multilayered generation and processing of computer instructions) based at least in part on the one or more inputs.

The remote computing system 630 includes the one or more computing devices 632. Each of the one or more computing devices 632 can include one or more processors 634, one or more memory devices 636, the data 638, and/or the instructions 640. The remote computing system 630 can include any of the attributes and/or capabilities of the computing system 610. Further, the remote computing system 630 can communicate with one or more devices and/or one or more systems via the network 602.

In some embodiments, the remote computing system 630 can include one or more applications (e.g., computer software applications comprising computer instructions) that can be stored and/or executed by the remote computing system 630. Further, the one or more applications can include one or more third-party applications that may be accessed from the computing system 610 and which are at least partly operated from the remote computing system 630. The one or more third-party applications generally may be associated with and provided by an organization that is different from the organization that is associated with the computing system 610. Further, the data 638 can include one or more portions of the organizational data (e.g., one or more organizational records), one or more data structures associated with the organizational data, rule data, organizational policy data, application policy data, third-party integration data, and/or other types of data.

One or more computing devices 652 (e.g., user devices or any other types of devices) can include one or more processors 654, one or more memory devices 656, the data 658, and/or the instructions 660. Such one or more computing devices 652 may include any of the attributes and/or capabilities of the one or more computing devices 612, 632. Further, such one or more computing devices 652 can communicate with one or more devices and/or one or more systems via the network 602.

In some embodiments, the one or more computing devices 652 can include one or more applications (e.g., computer software applications comprising computer instructions) that can be stored and/or executed by such one or more computing devices 652. Further, the one or more applications can include one or more third-party applications that may be accessed from the one or more computing devices 652 and which are at least partly operated from such one or more computing devices 652. Data 638 may include, for example, one or more portions of the organizational data (e.g., one or more organizational records), one or more data structures associated with the organizational data, rule data, organizational policy data, application policy data, third-party integration data (e.g., third-party application integration data), and/or other types of data.

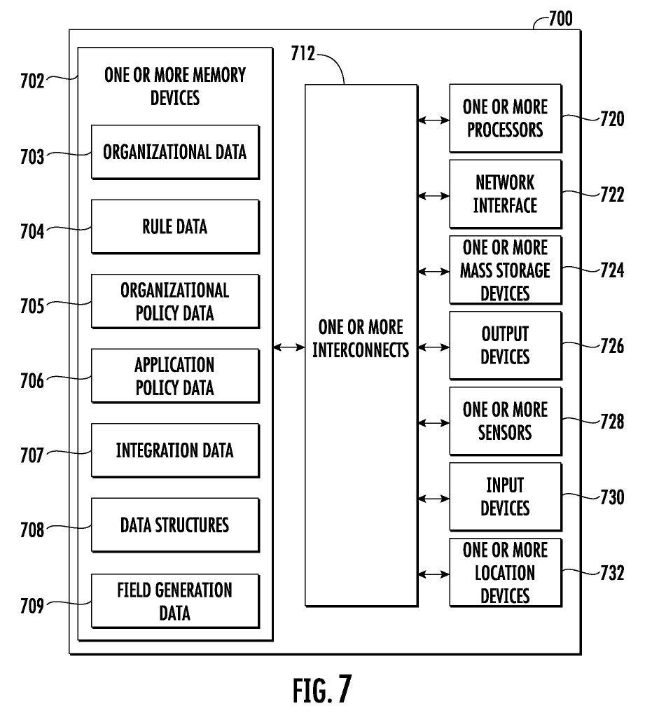

FIG. 7 depicts a block diagram of an example computing device 700 according to example embodiments of the present disclosure. The computing device 700 can include one or more attributes and/or capabilities of the computing system 610, the remote computing system 630, the one or more computing devices 652, and/or the computing device 700. Furthermore, the computing device 700 can be configured to perform one or more operations and/or one or more actions that can be performed by the computing system 610, the remote computing system 630, the one or more computing devices 652, and/or the computing device 700.

As shown in FIG. 7, the computing device 700 can include one or more memory devices 702, organizational data 703, rule data 704, organizational policy data 705, application policy data 706, integration data 707, data structures 708, field generation data 709, one or more interconnects 712, one or more processors 720, a network interface 722, one or more mass storage devices 724, one or more output devices 726, one or more sensors 728, one or more input devices 730, and/or one or more location devices 732.

The one or more memory devices 702 can store information and/or data (e.g., organizational data 703, rule data 704, organizational policy data 705, application policy data 706, integration data 707, data structures 708, and/or any other types of data). Further, the one or more memory devices 702 can include one or more non-transitory computer-readable storage media, including RAM, ROM, EEPROM, EPROM, flash memory devices, magnetic disks, and any combination thereof. The information and/or data stored by the one or more memory devices 702 can be executed by the one or more processors 720 to cause the computing device 700 to perform one or more operations associated with performing multilayered generation and processing of computer instructions (e.g., in association with computer instructions in a custom query language) across various types of applications and/or computer systems, including, for example, receiving a request comprising one or more instructions in a first computer language, parsing the one or more instructions in the first computer language in view of one or more rules associated with the first computer language, analyzing the one or more instructions in the first computer language in view of information describing structure of a first application, generating one or more instructions in a second computer language different from the first computer language with the one or more instructions in the second computer language being generated based on the one or more instructions in the first computer language and the information describing structure of the first application, obtaining a result from a second application where the result comprises information based on the one or more instructions in the second computing language, and providing the result in response to the request comprising the one or more instructions in the first computer language.

The organizational data 703 can include one or more portions of data (e.g., the data 618, the data 638, and/or the data 658, which are depicted in FIG. 6) and/or instructions (e.g., the instructions 620, the instructions 640, and/or the instructions 660, which are depicted in FIG. 6) that are stored respectively in any of the one or more memory devices 616, 636, 656. The organizational data 703 also can include information associated with one or more applications (e.g., one or more third-party applications), one or more organizational records and/or one or more organizational policies. In some embodiments, the organizational data 703 can be received from one or more computing systems (e.g., the remote computing system 630 depicted in FIG. 6) which can include one or more computing systems that are remote (e.g., in another room, building, part of town, city, or nation) from the computing device 700.

The rule data 704 can include one or more portions of data (e.g., the data 618, the data 638, and/or the data 658, which are depicted in FIG. 6) and/or instructions (e.g., the instructions 620, the instructions 640, and/or the instructions 660, which are depicted in FIG. 6) that are stored in the one or more memory devices 616, the one or more memory devices 636, and/or the one or more memory devices 656, respectively. The rule data 704 can include information associated with one or more rules that can be used to generate and/or implement an application policy. The rule data 704 also can include information associated with one or more rules of an organizational data management system (e.g., base or default rules provided or enforced by the system, one or more custom rules configured by an organization, etc.). The rule data 704 also can include one or more rules associated with implementing and/or utilizing a custom computer language, such as a custom computer language for performing operations associated with organizational data 703. In some embodiments, the rule data 704 can be received from one or more computing systems (e.g., the remote computing system 630 depicted in FIG. 6), which can include one or more computing systems that are remote from the computing device 700.

The organizational policy data 705 can include one or more portions of data (e.g., the data 618, the data 638, and/or the data 658, which are depicted in FIG. 6) and/or instructions (e.g., the instructions 620, the instructions 640, and/or the instructions 660, which are depicted in FIG. 6) that are stored in the one or more memory devices 616, the one or more memory devices 636, and/or the one or more memory devices 656, respectively. Furthermore, the organizational policy data 705 can include information associated with one or more organizational policies that are used to regulate one or more applications (e.g., one or more third-party applications), one or more computing devices, and/or one or more records which can include one or more organizational records and/or one or more employee records. In some embodiments, the organizational policy data 705 can be received from one or more computing systems (e.g., the remote computing system 630 depicted in FIG. 6) which can include one or more computing systems that are remote from the computing device 700.

The application policy data 706 can include one or more portions of data (e.g., the data 618, the data 638, and/or the data 658, which are depicted in FIG. 6) and/or instructions (e.g., the instructions 620, the instructions 640, and/or the instructions 660, which are depicted in FIG. 6) that are stored in the one or more memory devices 616, the one or more memory devices 636, and/or the one or more memory devices 656, respectively. Furthermore, the application policy data 706 can include information associated with one or more policies that are used to implement an application policy associated with one or more applications (e.g., one or more third-party applications), one or more computing devices, and/or one or more records which can include one or more organizational records and/or one or more employee records. In some embodiments, the application policy data 706 can be received from one or more computing systems (e.g., the remote computing system 630 depicted in FIG. 6) which can include one or more computing systems that are remote from the computing device 700.

The integration data 707 can include one or more portions of data (e.g., the data 618, the data 638, and/or the data 658, which are depicted in FIG. 6) and/or instructions (e.g., the instructions 620, the instructions 640, and/or the instructions 660, which are depicted in FIG. 6) that are stored in the one or more memory devices 616, the one or more memory devices 636, and/or the one or more memory devices 656, respectively. The integration data 707 can include configuration and/or operational information associated with integrating and synchronizing data (e.g., organizational data 703) among one or more applications. For example, the integration data 707 can include information that enables integration and synchronization between each of one or more applications (e.g., third-party applications and/or other applications). In an embodiment, the integration data 707 provides integration information that allows an organizational data management system (e.g., a system of record for organizational data and organizational data processing), for example, to obtain information from one or more applications (e.g., third party and/or other applications), to perform operations involving organizational data (e.g., organizational data 703) in the organizational data management system, to synchronize organizational data across one or more applications, to perform one or more actions involving the applications based on organizational data in the organizational data management system, and/or to perform one or more other operations associated with managing organizational data as a system of record. In some embodiments, the integration data 707 can be received from one or more computing systems (e.g., the remote computing system 630 depicted in FIG. 6), which can include one or more computing systems that are remote from the computing device 700.

The data structures 708 can include one or more portions of data (e.g., the data 618, the data 638, and/or the data 658, which are depicted in FIG. 6) and/or instructions (e.g., the instructions 620, the instructions 640, and/or the instructions 660, which are depicted in FIG. 6) that are stored in the one or more memory devices 616, the one or more memory devices 636, and/or the one or more memory devices 656, respectively. The data structures 708 can include one or more logical and/or physical instances of information representing or describing one or more entities (e.g., objects, records, etc.), one or more relationships involving one or more of the entities, one or more data values associated with each of one or more of the entities and/or one or more of the relationships, one or more functions and/or operations that may be applied to each of one or more of the entities and/or one or more of the relationships, any other data or metadata describing or otherwise defining structure and/or rules associated with one or more of the entities and/or one or more of the relationships, etc.

The data structures 708 can be implemented and utilized with one or more types of computer software, computer hardware, or any combination thereof. In an embodiment, the data structures 708 are used to represent and perform processing associated with various types of organizational data (e.g., organizational data 703). For example, the data structures 708 may include information about various types of information and entities associated with organizational data including, but not limited to, individuals (e.g., employees, vendors, independent contractors), departments, teams, roles, groups, locations, offices, documents, tasks, reports, accounts, devices, applications, end-user applications, licenses, workflows, alerts, and/or any other types of entities representing or related to managing organizational data (e.g., organizational data 703).

The data structures 708 also can define various relationships among the various entities associated with organizational data. For example, the data structures 708 may define and be used to enforce relationships such as each employee must be assigned to a department, each employee can be included on one or more teams, each employee must be assigned to a primary location, each employee may be assigned to one or more secondary locations, employees may have one or more computing devices, each vendor must have a current audit, each independent contractor must be associated with a contract, and/or any other relationships provided by an organizational data management system or configured for an organization that utilizes an organizational data management system (e.g., a system for managing organizational data 703 based on one or more organizational data management applications).

In some embodiments, the data structures 708 can include one or more object graphs providing information about entities, relationships, and/or any other aspects relating to the definition, structure, and rules associated with organizational data (e.g., organizational data 703). The data structures 708 also can include any one or more other types of data structures (e.g., with or without the use of object graphs) that provide information about entities, relationships, and/or any other aspects of the definition, structure, and/or rules associated with organizational data. In some embodiments, the data structures 708 can be received from one or more computing systems (e.g., the remote computing system 630 depicted in FIG. 6), which can include one or more computing systems that are remote from the computing device 700.

The one or more interconnects 712 can include one or more interconnects or buses that can be used to send and/or receive one or more signals (e.g., electronic signals) and/or data (e.g., organizational data 703, rule data 704, organizational policy data 705, application policy data 706, integration data 707, data structures 708, and/or any other data) between components of the computing device 700, including the one or more memory devices 702, the one or more processors 720, the network interface 722, the one or more mass storage devices 724, the one or more output devices 726, the one or more sensors 728 (e.g., a sensor array), the one or more input devices 730, and/or the one or more location devices 732. The one or more interconnects 712 can be arranged or configured in different ways. For example, the one or more interconnects 712 can be configured as parallel or serial connections. Further the one or more interconnects 712 can include one or more internal buses that are used to connect the internal components of the computing device 700 and one or more external buses used to connect the internal components of the computing device 700 to one or more external devices. By way of example, the one or more interconnects 712 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 720 can include one or more computer processors that are configured to execute the one or more instructions stored in the one or more memory devices 702. For example, the one or more processors 720 can, for example, include one or more general purpose central processing units (CPUs), application specific integrated circuits (ASICs), and/or one or more graphics processing units (GPUs). Further, the one or more processors 720 can perform one or more actions and/or operations including one or more actions and/or operations associated with the organizational data 703, the rule data 704, the organizational policy data 705, the application policy data 706, the integration data 707, the data structures 708, and/or any other data. The one or more processors 720 can include single or multiple core devices including a microprocessor, microcontroller, integrated circuit, and/or a logic device.

The network interface 722 can support network communications. The network interface 722 can support communication via networks including a local area network and/or a wide area network (e.g., the internet). For example, the network interface 722 can allow the computing device 700 to communicate with the computing system 610 via the network 602.

The one or more mass storage devices 724 (e.g., a hard disk drive and/or a solid-state drive) can be used to store data including the organizational data 703, the rule data 704, the organizational policy data 705, the application policy data 706, the integration data 707, the data structures 708, and/or any other data. The one or more output devices 726 can include one or more display devices (e.g., liquid crystal display (LCD), OLED display, mini-LED display, micro-LED display, plasma display, and/or cathode ray tube (CRT) display), one or more light sources (e.g., LEDs), one or more loudspeakers, and/or one or more haptic output devices (e.g., one or more devices that are configured to generate vibratory output).

The one or more sensors 728 can be configured to detect various states and can include one or more cameras, one or more light detection and ranging (LiDAR) devices, one or more sonar devices, and/or one or more radar devices. Further, the one or more sensors 728 can be used to provide input (e.g., an image of a user captured using the one or more cameras) that can be used as part of invoking or performing one or more operations. For example, the one or more sensors 728 can be used to authenticate the identity of a user and determine an authorization level based on an image of the user’s face that is captured using the one or more sensors 728.

The one or more input devices 730 can include one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to detect gestures that can trigger one or more operations by the computing device 700).

Although the one or more memory devices 702 and the one or more mass storage devices 724 are depicted separately in FIG. 7, the one or more memory devices 702 and the one or more mass storage devices 724 can be regions within the same memory module. The computing device 700 can include one or more additional processors, memory devices, and/or network interfaces, which may be provided separately or on the same chip or board. The one or more memory devices 702 and the one or more mass storage devices 724 can include one or more computer-readable media, including, but not limited to, non-transitory computer-readable media, RAM, ROM, hard drives, flash drives, and/or other memory devices.

The one or more memory devices 702 can store sets of instructions for applications including an operating system that can be associated with various software applications or data. For example, the one or more memory devices 702 can store sets of instructions for one or more applications (e.g., one or more organizational applications and/or one or more third-party applications) that are subject to one or more application policies or utilize third-party integration data that can be configured, generated, and/or implemented by the computing device 700 and/or one or more other computing devices or one or more computing systems. In some embodiments, the one or more memory devices 702 can be used to operate or execute a general-purpose operating system that operates on mobile computing devices and/or and stationary devices, including for example, smartphones, laptop computing devices, tablet computing devices, and/or desktop computers.

The software applications that can be operated or executed by the computing device 700 can include applications associated with the computing system 610, the remote computing system 630, and/or the one or more computing devices 652 that are depicted in FIG. 6. Further, the software applications that can be operated and/or executed by the computing device 700 can include native applications, web services, and/or web-based applications.

The one or more location devices 732 can include one or more devices or circuitry for determining the position of the computing device 700. For example, the one or more location devices 732 can determine an actual and/or relative position of the computing device 700 by using a satellite navigation positioning system (e.g. a GPS system).

Numerous details are set forth in the foregoing description. However, it will be apparent to one of ordinary skills in the art having the benefit of this disclosure that the present disclosure may be practiced without these specific details. In some instances, structures and devices are shown in block diagram form, rather than in detail, to avoid obscuring the present disclosure.

Some portions of the detailed description have been presented in terms of processes and symbolic representations of operations on data bits within a computer memory. Here, a process can include a self-consistent sequence of steps leading to a result. The steps can include those requiring physical manipulations of physical quantities. These quantities can take the form of electrical or magnetic signals capable of being stored, transferred, combined, compared, and otherwise manipulated. These signals can be referred to as bits, values, elements, symbols, characters, terms, numbers, or the like.

These terms and similar terms can be associated with physical quantities and can represent labels applied to these quantities. The terms including “obtaining,” “parsing,” “analyzing,” “accessing,” “determining,” “identifying,” “adjusting,” “modifying,” “transmitting,” “receiving,” “processing” “generating,” or the like, can refer to the actions and processes of a computer system, a computing device, or similar electronic computing device, that manipulates and transforms data represented as physical (e.g., electronic) quantities within the computer system’s registers and memories into other data that can be similarly represented as physical quantities within the computer system’s memories, registers, or other information storage device, data transmission device, or data processing device.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the claims.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a unified device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computing system that implements an organizational management platform that manages organizational data for an organization, the computing system comprising:
one or more processors; and
a document-oriented database that stores the organizational data associated with the organization, wherein the organizational data comprises an object graph data structure comprising a plurality of data objects that respectively correspond to a plurality of employees of the organization, and wherein each data object includes a dynamic attribute is defined by the organization;
an online analytical processing (OLAP) database having a base table and a dimension table, the base table storing raw data associated with the data objects, and the dimension table storing lookup data associated with the dynamic attribute; and
one or more non-transitory computer-readable media that collectively store instructions that, when executed by the one or more processors, cause the computing system to perform operations, the operations comprising:
receiving, from a user device, a user request for a report;
generating, based on the object graph data stored in the document-oriented database, a first query being expressed in a custom query language, the first query being associated with a first data object from the plurality of data objects;
retrieving, from the OLAP database, data from the base table based on the first query;
joining, using the lookup data, the retrieved data with the data from the dimension table to generate the report.

2. The computing system of claim 1, wherein the dynamic attribute associated with an employee is defined by the organization.

3. The computing system of claim 1, the custom query language is converted to a data access language, and wherein the data access language is used to access data from the OLAP database.

4. The computing system of claim 3, wherein the data access language is Structured query language (SQL).

5. The computing system of claim 1, the operations further comprising:
storing new data received from a user of the organization in the document-oriented database;
converting, using an automated extract, transform, and load (ETL) pipeline, the new data to converted data; and
storing, using the object graph data structure, the converted data in the OLAP database.

6. The computing system of claim 1, wherein the document-oriented database is a NoSQL database.

7. The computing system of claim 1, wherein the document-oriented database is stored on-device.

8. The computing system of claim 1, wherein the OLAP database includes a real-time and distributed OLAP datastore.

9. The computing system of claim 1, wherein the report is a job report based on the organizational data of the organization.

10. The computing system of claim 1, the operations further comprising:
generating permission filters for the OLAP database based on user privileges of the user device.

11. A computer-implemented method, comprising:
accessing a document-oriented database that stores organizational data associated with an organization, wherein the organizational data comprises an object graph data structure comprising a plurality of data objects that respectively correspond to a plurality of employees of the organization, and wherein each data object includes a dynamic attribute is defined by the organization;
accessing an online analytical processing (OLAP) database having a base table and a dimension table, the base table storing raw data associated with the data objects, and the dimension table storing lookup data associated with the dynamic attribute;
receiving, from a user device, a user request for a report;
generating, based on the object graph data stored in the document-oriented database, a first query being expressed in a custom query language, the first query being associated with a first data object from the plurality of data objects;
retrieving, from the OLAP database, data from the base table based on the first query;
joining, using the lookup data, the retrieved data with the data from the dimension table to generate the report.

12. The method of claim 11, wherein the dynamic attribute associated with an employee is defined by the organization.

13. The method of claim 11, the custom query language is converted to a data access language, and wherein the data access language is used to access data from the OLAP database.

14. The method of claim 13, wherein the data access language is Structured query language (SQL).

15. The method of claim 14, the method further comprising:
storing new data received from a user of the organization in the document-oriented database;
converting, using an automated extract, transform, and load (ETL) pipeline, the new data to converted data; and
storing, using the object graph data structure, the converted data in the OLAP database.

16. The method of claim 11, wherein the document-oriented database is a NoSQL database.

17. The method of claim 11, wherein the document-oriented database is stored on-device.

18. The method of claim 11, wherein the OLAP database is a Pinot database.

19. The method of claim 11, wherein the report is a job report based on the organizational data of the organization.

20. One or more tangible non-transitory computer-readable media storing computer-readable instructions that, when executed by one or more processors, cause the one or more processors to:
accessing a document-oriented database that stores organizational data associated with an organization, wherein the organizational data comprises an object graph data structure comprising a plurality of data objects that respectively correspond to a plurality of employees of the organization, and wherein each data object includes a dynamic attribute is defined by the organization;
accessing an online analytical processing (OLAP) database having a base table and a dimension table, the base table storing raw data associated with the data objects, and the dimension table storing lookup data associated with the dynamic attribute;
receiving, from a user device, a user request for a report;
generating, based on the object graph data stored in the document-oriented database, a first query being expressed in a custom query language, the first query being associated with a first data object from the plurality of data objects;
retrieving, from the OLAP database, data from the base table based on the first query;
joining, using the lookup data, the retrieved data with the data from the dimension table to generate the report.
